(19) United States
(12) Patent Application Publication
(10) Pub. No.: US 2017/0330281 A1
(43) Pub. Date: Nov. 16, 2017

(54) MicroAnnuityMutual (MAM)

(71) Applicant: Matthew Halperin, Wayland, MA (US)

(72) Inventor: Matthew Halperin, Wayland, MA (US)

(21) Appl. No.: 15/597,072

(22) Filed: May 16, 2017

Related U.S. Application Data
(60) Provisional application No. 62/336,859, filed on May 16, 2016.

(51) Int. Cl. G06Q 40/06; G06Q 10/06; G06Q 40/08; H04L 29/06

(52) U.S. Cl. CPC G06Q 40/06; G06Q 40/08; G06Q 10/06393; H04L 63/0428

(57) ABSTRACT

Embodiments of the invention are directed towards systems, methods and computer program products for the creation and capitalization of an investment vehicle, the method comprising: creating a limited purpose insurance company; accepting equity investments in the insurance company from an employer in exchange for one or more units of equity, a portion of a given unit of equity associated with an employee of the employer; and purchasing one or more annuities with at least a portion of one of the one or more equity investments.

### CROSS-REFERENCE TO RELATED APPLICATIONS

The present application claims priority to U.S. Patent Application No. 62/336,859, filed on May 16, 2016, entitled “MicroAnnuityMutual (MAM),” the contents of which are hereby incorporated by reference in its entirety herein.

### BACKGROUND OF THE INVENTION

Various schemes are known in the art for providing income for the life of an individual. Many such schemes and plans have been in existence for centuries. For example, tontines, created in the 17th century (the first annuity provider in the US was the Presbyterian Ministers Fund in 1759) are investment plans for raising capital, devised in the 17th century and relatively widespread in the 18th and 19th centuries. Tontines combine features of a group annuity and a lottery. Each subscriber pays an agreed sum into the fund, and thereafter receives an annuity. As members die, their shares devolve to the other participants, and so the value of each annuity increases. On the death of the last member, the scheme is wound up.

Similarly, defined benefit (“DB”) plans were popularized in the 20th century. Defined benefit plans are a type of pension plan in which an employer/sponsor promises a specified pension payment, lump-sum (or combination thereof) on retirement that is predetermined by a formula based on the employee's earnings history, tenure of service and age, rather than depending directly on individual investment returns. Defined benefit plans in the US have fallen out of favor as corporations and, increasingly, states and municipalities, deal with underfunded plans or poor investment results. Annuities, while not popular in corporate plans, are highly successful in the higher education “403b” market where IRS rules require plans to invest in either mutual funds or annuities

There are tensions between the desires for increased exposure to potential profit, while also desiring to minimize potential loses. There are also major differences between annuities and defined benefit plans, which can influence how and when each one becomes appropriate for a retiree or saver. Defined Benefit plans are requirements to pay, which are made by the plan sponsor and can therefore be underfunded. By contrast, annuities are guarantees of payment by an insurance company. Annuity payments are guaranteed by an insurance company and put its capital at risk. As such, insurance company annuity payments are backstopped (in whole or part depending on the state) through guarantees by state funds in the event of an insolvency event. There have been attempts to overcome the mismatch of incentives between savers and managed in defined benefit plans. For example, U.S. Pat. No. 8,249,900, the contents of which are herein incorporated by reference as if presented in their entirety, describes systems and method for terminating a pension plan through mutual annuitization.

As an annuity is guaranteed by an insurance company, the annuity must operate in conformance with state insurance laws designed to prevent insolvency. These laws dictate transparency regarding financials and set reserve minimums, as well as limit investment in risky assets.

A for profit insurance company is run for the benefit of its owners. Given the competing drawbacks from which each of these investment vehicles suffers, what is needed in the art is a retirement investment vehicle that serves only to benefit a group or groups of employees and appropriately aligns incentives.

Furthermore, what is needed in the art is an automatically generated and managed virtual commercial entity (such as a virtual insurance company) funded by capital contributions of the employees' employers and having the obligation to provide annuities that pay out during retirement in a manner that replaces traditional defined benefit plans.

Embodiments of the present invention provide these features in addition to other features and benefits.

### SUMMARY OF THE DISCLOSURE

Embodiments of the invention are directed towards systems, methods and computer program products for the creation and capitalization of an investment vehicle, the method comprising: creating a limited purpose insurance company; accepting equity investments in the insurance company from an employer in exchange for one or more units of equity, a portion of a given unit of equity associated with an employee of the employer; and purchasing one or more annuities with at least a portion of one of the one or more equity investments.

In a further implementation, a method is provided for creating a virtual commercial entity vehicle comprising the steps of receiving a request to create a virtual commercial entity; parsing the request for one or more data values corresponding to operational parameters of the requested virtual commercial entity; generating a virtual commercial virtual commercial entity using at least one of the parsed data values. Additionally, the method also includes accessing a library of operational parameters not parsed from the request for one or more virtual commercial entities, selecting one or more additional operational parameters, and associating the selected operational parameters with the virtual commercial entity.

Further embodiments of the systems, method and computer products described herein are directed towards the creation of a highly capitalized mutual life insurance company with outsourced management, which only provides participating annuities to savers, e.g., a MicroAnnuityMutual (“MAM”). Although the virtual company offers participating annuities that have a low guaranteed rate of return, such annuities receive what the insurer earns on the investment portfolio. According to one embodiment, an insurer capitalizes the virtual company with equity provided by an employer from the employer's 401k match on employee contributions.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a flow diagram illustrating a method for creating a virtual company according to one embodiment of the present invention;

FIG. 2 presents a flow diagram illustrating a method for investing in and annuitizing a virtual company according to one embodiment of the present invention; and

FIG. 3 presents a block diagram illustrating certain elements according to one embodiment of the present invention.

### DETAILED DESCRIPTION OF EMBODIMENTS OF THE INVENTION

By way of broad overview and introduction, one or more particular implementations or embodiments provided herein includes methods for creating one or more limited-purpose companies, or other type or category of virtual or virtualized company, to provide good or services to a client, such an employer, employee or saver.

In one non-limiting implementation, a virtual limited purpose company is created automatically so as to provide participating annuities to savers. Here, an annuity is a guarantee by a life insurance company to provide a stream of income (which itself may be guaranteed, participating or variable) in exchange for a lump sum payment or series of payments. However, as used throughout, the term ‘annuity’ can be applied to, or is reference to any payment or series of payments that are pre-determined or pre-defined based on one or more initial conditions, contractual terms, or events. Annuities provided according to the implementations described herein can include immediate and delayed annuities. For instance, the virtual purpose company provides an annuity to one or more savers that begins making periodic payments shorty after creation or generation or after a pre-determined time, or upon the occurrence of a specified event.

The virtual company structure described herein eliminates common issues with traditional defined benefit plans and annuities, thereby providing an alternative investment structure for retirement plan providers. For example, the virtual company described herein eliminates or reduces the risk of underfunding, lack of transparency and misalignment between the incentives of the firm and the employees' common in other plans. For annuities, the largest issue for plan fiduciaries is credit risk of the insurance company providing the annuity: will the insurer be solvent in 40 years and pay on the annuity? Second order risks are that the interest of the annuitant is at odds with equity holders. In the case of mutual insurers (which are owned by its members), such entities are run for growth, not in accordance with any capital discipline expectations. Any firm, government entity (state, municipality, etc.), non-profit or union or group of these can create such a virtual company to advance these goals. The limited mandate and automatic or outsourced management ensure that costs are kept low. Likewise, the transparency of the underlying value of capital of the virtual company encourages participant uptake.

Unlike existing vehicles, the virtual company provides a structure whereby risk and reward are properly aligned. In a traditional defined benefit plan, it is easy for management to make promises on payouts and leave such commitments to future years to pay an increased defined benefit payout when payers look to collect. Risky investments can lead to payouts that do not surpass capital paid into the plan or other future problems where such investments fail. In regard to annuities, the virtual company minimizes credit risk by designing minimum capital level requirements. A virtual company allows plan fiduciaries to manage the critical functions of their virtual company by replacing under performing vendors and fulfilling their fiduciary obligation. Other non-limiting differences between a virtual company and a traditional insurer are the manner in which the insurer is capitalized, as well as requirements to limit the business activities to providing annuities and remaining well capitalized through acquisition of a diversified investment portfolio. As such, the systems and methods provided herein enable the creation of limited purpose companies that only provide participating annuities to savers (e.g. equity owners). Here, the capital for the virtual company will come from the employer. Savers, the employees, obtain both equity and annuity units in exchange for contributions or deposits. In return, the described virtual company provides annuities that pay in retirement, replacing traditional defined benefit plans with annuities that align risk and reward with the savings goals of employees.

As provided in more detail herein, one implementation of the virtual company generation and management system concerns utilizing one or more processors configured by code executing therein to implement the creation of a virtualized or virtual company having pre-determined or variable equity quantities. One purpose of such a virtualized company is to provide an annuity to the owners of the equity of such a virtualized company upon the triggering of an event. For example, the systems and methods described herein are directed to a computer implemented method of utilizing a processor, such as a virtual company management server 302, to generate a virtual company as a limited purpose life insurer. Such a virtual company management server 302 ensures that the virtual company generated only provides participating annuities and is run as a low cost company. In a further implementation, the systems and methods described herein are directed to the computer implemented or automatic maintenance, operation, and liquidation of one or more virtual companies.

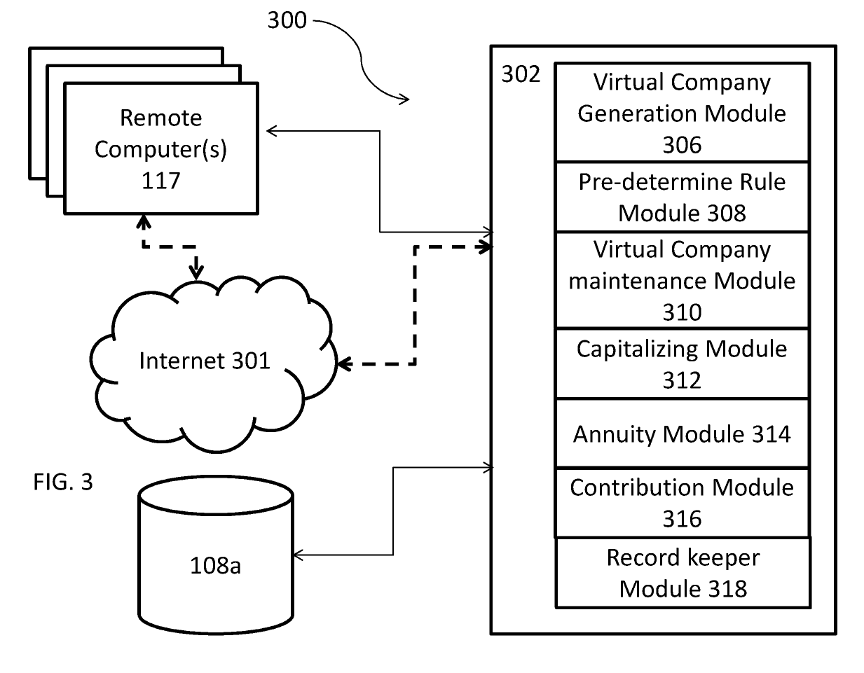

With particular reference to FIG. 3, a virtual company generation, operation and maintenance system 300 described herein includes a virtual company management server 302, comprising one or more suitably configured processors. The virtual company management server 302 is configured to process requests to generate one or more virtual companies, access one or more datasets of information relevant to virtual company generation, access remote data provided by third parties and to communicate stored information, material or content to other local or remote data processing systems. The virtual company management server 302 is configured to evaluate the accessed information material and content from a remote database 108a. In another implementation, the virtual company management server 302 is configured to access datasets from one or more remote storage locations accessible via a network or the Internet.

As used herein, “processor” or “computer” refers one or more electronic devices (e.g. semiconductor based microcontrollers) configured with code in the form of software, to execute a given instruction set. For example, the virtual company management server 302, database(s) 108a and remote computer(s) 117, include one or more processing or computing elements executing commercially available or custom operating system, e.g., MICROSOFT WINDOWS, APPLE OSX, UNIX or Linux based operating system implementations.

Referencing FIG. 3, the virtual company management server 302 includes one or more software or hardware modules executed on a computing device or processor that collectively configures a processor(s) or computer(s) to implement the functionality of evaluating and modifying messages. For example, the virtual company management server 302 is computing device, such as a server; cloud based system, or other computing environment.

In a particular implementation, the virtual company management server 302 includes a single processor, multiple discrete processors, a multi-core processor, or other type of processor(s) known to those of skill in the art, configured by code to evaluate and mediate communications by and between remote devices. As used herein, the virtual company management server 302 is configured with one or more remote or local data storage devices that store operating code, as well as user information. The virtual company management server 302 is also configured to access remote resources such as third party vendor information, user data, and communication data from third parties through implementation of code modules.

In other implementations, the virtual company management server 302, database(s) 108 and remote computer(s) 117 each include custom or non-standard hardware, firmware or software configurations. For instance, the processor or computer can include one or more of a collection of micro-computing elements, computer-on-chip, home entertainment consoles, media players, set-top boxes, prototyping devices or “hobby” computing elements. Such computing elements described are connected, directly or indirectly, to one or more memory storage devices (memories) to form a microcontroller structure. The memory is a persistent or non-persistent storage device that is operative to store an operating system for the processor in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. The computer memories may also comprise secondary computer memory, such as magnetic or optical disk drives or flash memory, that provide long term storage of data in a manner similar to the persistent memory device. In one or more embodiments, the memory of the processors provide for storage of application programs and data files when needed.

The processors or computers described are configured to execute code written in a standard, custom, proprietary or modified programming language such as a standard set, subset, superset or extended set of JavaScript, PHP, Ruby, Scala, Erlang, C, C++, Objective C, Swift, C#, Java, Assembly, Go, Python, Pearl, R, Visual Basic, Lisp, or Julia or any other object oriented, functional or other paradigm based programming language.

In one implementation, virtual company management server 302 can be selected from or implemented on one or more portable computing devices such as Apple iPad/iPhones®, Android® devices or other electronic devices executing a commercially available or custom operating system, e.g., MICROSOFT WINDOWS, APPLE OSX, UNIX or Linux based operating system implementations. In other implementations, virtual company management server 302 is or includes custom or non-standard hardware, firmware or software configurations. Here, the virtual company management server 302 can communicate with the one or more remote networks using USB, digital input/output pins, eSATA, parallel ports, serial ports, FIREWIRE, Wi-Fi, Bluetooth, or other communication interfaces. In a particular configuration, the virtual company management server 302 are also configured, through hardware and software modules, to connect to more remote servers, computers, peripherals or other hardware using standard or custom communication protocols and settings (e.g., TCP/IP, etc.) either through a local or remote network or through the Internet.

With particular reference to FIG. 3, the database is one or more data stores 108a in communication with the processor of the virtual company management server 302. The physical structure of the database(s) 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB in addition to other systems for the structure and retrieval of data that are well known to those of skill in the art. The database 108 includes the necessary hardware and software to enable a processor local to the virtual company management server 302 to retrieve and store data within the database 108.

The virtual company management server 302 accesses data or content through the Internet, a local area network, or intranet. With more particular reference to FIG. 3, the remote computers 117 are used to exchange data, such as electronic messages, over a network to the virtual company management server 302. In one implementation, the remote computers 117 connect to the virtual company management server 302 directly, such through an internal local network. Alternatively, remote computers 117 connect to the virtual company management server 302 by first connecting to the Internet.

As used herein, the remote computer 117 can be a general or single purpose computing device configured by hardware or software modules to connect to a network and transmit or receive data from the virtual company management server 302. For example, the remote computer 117 is a personal communication device (smartphone, tablet computer, etc.), configured by one or more code modules to exchange data with the virtual company management server 302. Remote computers 117 utilize wired or wireless communication means, such as, but not limited to CDMA, GSM, Ethernet, Wi-Fi, Bluetooth, USB, serial communication protocols and hardware to connect to one or more access points, exchanges, network nodes or network routers.

Returning to FIG. 3, in one particular implementation the virtual company management server 302 is a server, computing cluster, cloud platform or computing array, configured to directly, or through a communication linkage, communicate and exchange data with the one or more remote computers 117. As provided in the illustrated implementation, the virtual company management server 302 is a computer server configured by code executing therein to accept electronic data queried from one of more remote data storage locations and evaluate the queried or accessed data according to pre-determined or dynamic rules, logic, instructions or algorithms.

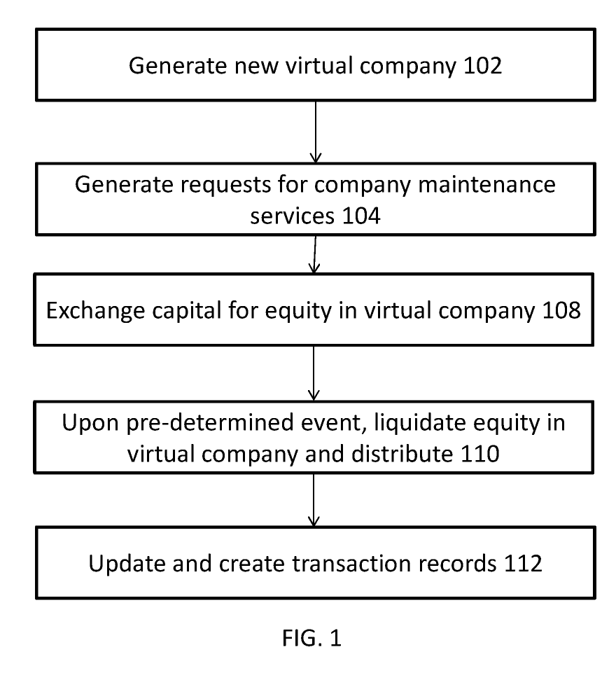

The virtual company management server 302 is further configured to generate, upon receipt of a request to generate a new virtual company, one or more initial features of a virtual company. In a particular implementation, a user (such as one using a remote computer 117) submits a request to the virtual company management server 302. As shown in step 102 of FIG. 1, upon receipt of the request, the virtual company management server 302 generates a data object or dataset that represents the virtual company; here this company dataset operates as an electronic charter or similar regulatory approval instrument. In one particular implementation, the virtual company is generated using a template or other pre-determined data object that closely or exactly matches the requirements or request submitted by the user.

For instance, upon receipt of the user request that includes data corresponding to a desired participating virtual company, a virtual company generation module 304 configures the processor of the virtual company management server 302 to select from a number of pre-set virtual company types stored in a local or remote memory and generate the virtual company. In one implementation, generating the virtual company includes creating a database or a table within a database and associating the electronic charter with the database. Additionally, one or more user accounts established and linked to the database. Furthermore, one or more transaction accounts, such as bank accounts, brokerage accounts or other financial transaction accounts are associated with the newly generated database or table.

It will be appreciated that the electronic charter governing the virtual company, and any accounts linked or associated with the virtual company can be stored in a database, such as database 108a. Thus, virtual company management server 302 is configured to manage or operate a number of virtual companies concurrently or simultaneously. Furthermore, in a particular implementation a single account is associated with the virtual company management server 302. Here, the virtual company management server 302 is configured to allocate or apportion the assets into virtual sub accounts so as to limit the number of actual transaction accounts used by the virtual company management server 302. As such, it is possible that multiple virtual companies may be managed simultaneously by the virtual company management server 302 using a single transaction account, such as a bank or brokerage account.

In a further implementation, the request to generate the virtual company can include data indicating the type and nature of the virtual company. Here, the virtual company management server 302 is configured to generate a participating style virtual company. Here ‘participating’ style means that savers are paid what the company earns on its investments each year, whereas life and annuity insurers typically pay a fixed rate of interest. The virtual company management server 302 is further configured to generate a virtual company that has “limited purpose”. Here “limited purpose” refers to virtual companies that are setup to only provide annuities and all aspects of management are outsourced by competitive bid and/or handled automatically.

In a further configuration, the virtual company management server 302 receives from the requesting user, a collection of pre-set conditions for the operation and/or management of the virtual company. In a particular implementation, the pre-set conditions are provided as code suitable for execution by one or more processors. In an additional implementation, the pre-set conditions are provided as smart contracts, self-executing contracts or other logic enabled datasets that operate as a computerized transaction protocol that executes the terms of a contract or clause.

Alternatively, the user request is parsed by one or more modules of the virtual company management server 302 to determine initial conditions, requirements or operational parameters of the virtual company. Here, one or more natural language processing algorithms, or other text parsing implementations are used to extract from the request, the desired form and conditions of the virtual company. For example, a request for the generation of a virtual company could include a minimal amount of classified or categorical information regarding the operational parameters of the virtual company, but include text or a message data that indicates additional desires or needs relating to the virtual company. Here, one or more additional parameters for the operation of the virtual company (e.g. capitalization amount, risk rates, contribution amounts) are automatically determined by the virtual company management server 302 configured by the virtual company generation module 306.

Additionally, the virtual company management server 302 is configured by the virtual company generation module 306 to transmit or send the generated output datasets (such as the account information associated with the generated virtual company) to one or more remote computers 117 or to the database 108a.

In a particular implementation, the virtual company management server 302 is configured by the virtual company generation module 306 to generate a virtual company designed to provide savers (individuals who contribute financial assets to the virtual company) a variable payment stream upon the occurrence of an event. It should be noted that there exists a psychological pre-disposition for savers to prefer a defined benefit plan. The annuities (preset payments) invested in by the virtual company act like a defined benefit by creating a stream of income in retirement that looks like a pension payment. The difference is that the payment by the virtual company is not guaranteed, but rather it can go up or down.

Here, the virtual company management server 302 is configured to provide savers a payment stream that under promises and over delivers on return. Such outcomes are provided by generating a virtual company that automatically manages the investment return, pays out of equity, and obtains superior investment results through cost management.

In a particular implementation, the generated virtual company is configured by the virtual company generation module 306 to set or select the timeframe for payment of the annuities. For instance, the electronic charter of the virtual company can include one or more data variables that indicate the payment of an annuity will begin immediately upon formation of the virtual company. In this instance, the virtual company might be capitalized fully by a third party or other funding source. Alternatively, the electronic charter of the virtual company can include one or more data variables that indicate the payment of an annuity will not begin until a pre-determined capital level is achieved, a pre-determined event has transpired, or other occurrence that may be pre-set or variable on other conditions referenced in the electronic charter or accessed by third party data feeds.

As part of the virtual company generation process, the virtual company generation module 302 configures the virtual company management server 302 to establish rules or pre-set conditions on the operation or functionality of the virtual company, when such functionality is not specified in the request. For example, a pre-determined rule module 308 configures the virtual company management server 302 to set the following conditions or operational parameters on the newly generated company:
1. Capital requirements (insurer maintains capital equivalent of at least an [A] rated company).
2. Staffing levels (all functions outsourced—zero to minimal full time employees)
3. Capital return options (such as capital return through annuitization)
4. Board member composition.
5. Board of directors remuneration (maximum level of remuneration per board of director).
6. Board of director composition (majority of board of directors to be plan fiduciaries according to one embodiment so they can act in their fiduciary capacity to oversee outsourced vendors.
7. Cashability (limited or zero so as to invest for long term).
8. Payout duration and
9. General Incentives structures configured so that virtual company provides best rate without conflicts.

For instance, the pre-determined rule module 308 causes the virtual company management server 302 to update the electronic charter governing the virtual company so that a pre-determined number, or percentage, of board member seats for the virtual company will be available to saver representatives, optionally with a required term limit. Likewise, the pre-determined rule module 308 causes the virtual company electronic charter to reference an acceptable fee to be charged to the virtual company by any board members or collective of board members. For example, the pre-determined rule module 308 provides a maximum compensation for any board member to be limited to the average hourly earnings of the board members' primary employment.

Those possessing an ordinary level of skill in the requisite art will appreciate that generating a virtual company according to the following pre-determined rules and guidelines solves a number of problems that plague current retirement income schemes. First, the virtual company operates to the interest of savers. With current defined benefit plans, the risk is borne by saver, whereas reward is shared with the sponsor (Corporation, state plans etc.). This stems from the fact that plans can be underfunded and are otherwise dependent on sponsor funding—windfall gains simply reduce the future capital investments to which the sponsor would have otherwise been exposed. Risky investments similarly reduce the need for plan funding when successful, but require funding or other topping off in the future when a failure. virtual company solves these problems by promising to pay on the contract only what is required by law to be an annuity, and then paying all portfolio earnings to savers in either annuity payment or increase in equity value.

A problem that arises in current for profit insurers is that the capital of the company is managed for benefit of equity holders. Rewards from risky investments accrue to shareholders due to the fact that payouts on annuities are limited to what is required by the insurance contract. When deciding how much to pay annuitants, equity holders compete with the annuitant. The virtual company described herein solves this problem by making the annuitant the equity holder.

Plan sponsors also have addressable concerns, such as future decades of credit risk in offering annuities and events that must transpire in the event that the insurer fails. The virtual company structure allows the plan get the benefit of offering a defined benefit through an annuity without giving up control; the plan can fire any vendor—the investment manager or the actuary or record keeper—thereby maintaining control at the level of each outsource vendor. Furthermore, using one or more computer implemented methods and systems; vendor performance is tracked monitored by the virtual company management server 302. Where a vendor performs poorly, the virtual company management server 302 updates the database 108a with a performance level or evaluation of the vendor.

In addition to overcoming several shortcomings with existing investment vehicles for retirement investment, the virtual company presents a number of benefits. As shown with respect to step 104, the virtual company management server 302 generates and sends requests for company management services. For example, current mutual companies can be run for the benefit of management, such that they are managed for growth and not capital discipline. Instead, the virtual company generates request for a variety of services needed by the virtual company such as record keeping, actuarial, investing, legal, finance. For example, a virtual company maintenance module 310 configures the virtual company management server 302 to select, from one or more lists of pre-approved vendors, suitable vendors to handle various tasks for the virtual company. As an example, a proposed virtual company might have record keeping or investing needs that are similar to other previously generated virtual companies. Using one or more machine learning algorithms (Bayesian classifiers, Support vector regression, logistic regression, adaptive neural, Laplace matrix, etc.) the virtual company evaluates the requirements of the virtual company (as provided in the virtual company electronic charter) and selects an appropriate vendor for the particular service needed according to the electronic charter.

In a further implementation, the virtual company maintenance module 310 configures the virtual company management server 302 to select one or more vendors based on the requirements provided in the electronic charter, such as acceptable pricing, locality, performance level or specialty. Vendors thus selected enter into contracts with a given virtual company and provide only needed services, thereby dis-incentivizing grow for growths sake.

In still further implementations, the virtual company management server 302 is configured by the virtual company maintenance module 310 to access one or more data values corresponding to industry standard operational parameters for insurance companies. By doing so the virtual company structure allows for savers to get the benefit of professional investment management at low cost institutional rates. The virtual company is an annuity, so lifetime income is guaranteed and savers get the benefits of life risk pooling. However, if a given saver dies early in retirement they will have a smaller estate. Conversely, they can never outlive their income. Savers do not need to risk various withdrawal heuristics (rule 4%) to de-accumulate. Accordingly, the virtual company structure allows the saver to spend down his or her savings without exhausting available funds prior to death.

Fiduciaries of the retirement plan can exercise control through the Board by firing poor performing vendors. Insurance regulation provides great minimum service and reporting standards for insurers.

In accordance with one embodiment, the virtual company structure is uniquely capitalized through employer contributions. As shown in step 108, the virtual company management server 302 is configured by a capitalizing module 312 to access or receive financial transaction information or instruments (such as a checking account or employer check) and apply or credit such financial information or instruments to the balance of accounts corresponding to the virtual company.

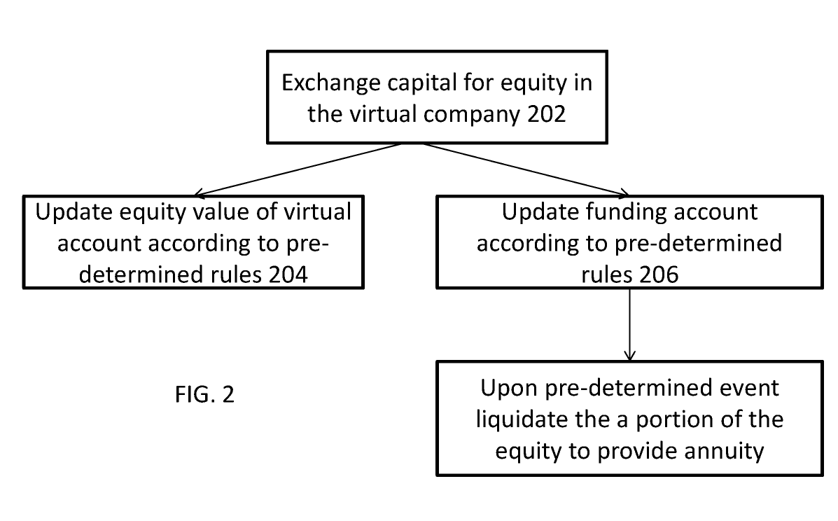

As shown in more detail in FIG. 2, a virtual company generated upon request of a given employer, includes a pre-set number of shares, or equity, of the virtual company. Employees of the company seeking to save money for future events, such as retirement, are provided with an account or transaction authorization number. This authorization code or account identifier permits the employee to transfer financial assets or instruments (such a portion of pre or post tax income received from the employer) to the virtual company as shown in step 202. For example, employee contributions to a variable payment stream of the virtual company are matched by the employer with equity units in the virtual company at the level of an AA insurance company. For example, assume $4 in premium to $1 in capital, which is realistic for AA insurance company. Employer contributions come in as equity units, whereas insurers typically obtain equity from the capital markets or private equity investors.

The capitalizing module 312 further configures the virtual company management server 302 to calculate the book value of the equity is fair valued each month and the employer buys new issue treasury stock, as shown in step 204. For example, the virtual company management server 302 is configured to access and analyze various security market factors that contain information about how the underlying assets of the fund would be valued in a liquid market. Thus, as employees contribute monthly to the annuity option in their retirement plan, the sponsor contributes stock to the saver as shown in step 206. The virtual company management server 302 is configured by the capitalizing module 312 to invest in the portfolio of the virtual company. For example, the virtual company can acquire using the contributions of the employees, various assets such as fixed or non-fixed income securities such as equity, real estate etc. The capitalizing module 312 configures the virtual company management server 302 to provide to users or savers value of the equity as it gets fair valued each month.

Prior to a pre-determined event, the virtual company management server 302 operates to make investments, either automatically, or through the financial management services of a vendor selected according to step 104. However, once a saver has reached a milestone or pre-determined event, the virtual company management server 302 is configured by the annuity module 314 to transfer financial assets back to the particular saver based on their current balance with the virtual company. For example, the virtual company management server 302, configured though the pre-determined rule module 308, access one or more employment lists or histories for a saver. Here, the virtual company management server 302 accesses the retirement date of a saver, or a data object indicating that the saver has retired.

At retirement, the virtual company management server 302, configured by the annuity module 314 annuitizes the equity of their contribution to the virtual company, as well the value of their own contributions previously deposited. For example, when an employee retires, the virtual company management server 306 configured by the annuity module 314 causes the saver's capital units to be liquidated and paid out as the policy pays annuity. Such liquidation occurs according to a schedule, which may be set by an administrator of the virtual company, or according to a pre-set rule provided in the virtual company electronic charter. It will be understood that the equity serves to supplement the annuitization of the savers own money. In the event of the death of a saver, the virtual company management server 302 is configured to evaluate the predetermined rules in the virtual company electronic charter and determine, based on the charter, whether to return the equity or lose in risk pooling. In this way, each saver, upon occurrence of the event (either death or retirement) provides the capital against his annuity leaving the capital ratio of the virtual company intact.

In a further implementation, a contribution module 316 configures the virtual company management server 302 to calculate monthly premiums using a vintage structure. In the described implementation, each month, management (such as a contracted entity) sets a rate that new money will be credited with the vintage, e.g., January 2016. Alternatively, the virtual company management server 302 accesses a third party data feed or source and determines or calculates the rate of new money credits based on the data feed. For instance, the virtual company management server 302 is configured to access data relating to the set rate at least once per month. Thus, while each month the rate may change, and as a result a new vintage is created. Creating vintages aligns risk and return as contributions are received from one or more savers. A given vintage is assigned a unique identifier like a cusip. Furthermore, as described above with regard to the rate setting process, rate setting will have explicit charge for risk that sits in equity. Since each saver bears the risk, everyone remains adequately compensated.

In a particular implementation, the contribution module 316 configures the virtual company management server 302 to calculate new money rates by determining that:
1. New Money rates are set monthly based on expected portfolio yield less risk charge.
2. Risk charge held by equity holders and equity holders pay losses.
3. As risk charge gets paid back to all insured, conservatism in risk hold back for riskier assets will not hurt insurers in the long run as they get back the hold back over time, as opposed to shareholders.
4. Rates are reset monthly or when markets move such that fairness indicates a creation of a new vintage.
5. Income off of existing contracts gets rolled into new money rates.
6. As bonds mature and get reinvested, rate on a vintage can change (vintages may get rolled up into other vintages).

While unfortunate, any financial product includes the possibility of losses. In one or more implementations, where there are credit losses in equity accounts, the capitalizing module 312 configures the virtual company management server 302 to debit to equity any such across all vintages.

As shown in step 112, for a given saver, a designated virtual company record keeper track monthly contributions, rates associated with that contribution and changes to rates associated with that contribution. For instance, a Record keeper module 318 configures the virtual company management server 302 to apply a rate to the savings of a given saver to compute interest earned for that individual. The record keeper module 318 further configures the virtual company management server 302 to track equity contributions and matches from an employer, which according to one embodiment, is a unit value of contribution. An administrator for a virtual company can decide how often interest is credited, e.g., monthly, quarterly, etc. Alternatively, the electronic charter includes data points indicating how often interest is credited.

In a further implementation, the record keeping step 112 includes providing breakdowns or accumulations of individual account balances and positions for a particular saver's annuities. For instance, the record keeper module 318 configures the virtual company management server 302 to keep track of the annuity values of multiple accounts linked to a single employer, employee, or saver. Here, the record keeper module provides information on annuity streams that are reported as part of a plan (e.g. an annuity that is part of saver's 401k, 403b etc. plan). As a non-limiting example, the record keeper module 318 configures the virtual company management server 302 to generate a report detailing the amounts a saver has accumulated one or more annuities that are only broadly and collectively reported on an accumulated basis. In this way, sub-balances or accounts are tracked in real or near real time so that savers, reporting agencies and others may make decisions regarding the disbursement, investment or reporting on the annuities.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

What is claimed is:

1. A method for capitalization of an investment vehicle, the method comprising:
creating a limited purpose insurance company;
accepting equity investments in the insurance company from an employer in exchange for one or more units of equity, a portion of a given unit of equity associated with an employee of the employer; and
purchasing one or more annuities with at least a portion of one of the one or more equity investments.

2. The method for capitalization of an investment vehicle of claim 1, wherein upon determination of an event, liquidating the one or more units of equity.

3. The method of claim 1, further comprising
accessing a first value of each unit of equity associated with an employee from a datastore,
comparing on a periodic basis, the accessed first value of each unit of equity to a list of present values for each unit of equity, and
updating the value of each unit of equity based on the comparison.

4. A method for creating a virtual commercial entity vehicle comprising the steps of:
receiving a request to create a virtual commercial entity;
parsing the request for one or more data values corresponding to operational parameters of the requested virtual commercial entity;
generating a virtual commercial virtual commercial entity using at least one of the parsed data values;
accessing a library of operational parameters not parsed from the request for one or more virtual commercial entities, selecting one or more additional operational parameters; and
associating the selected operational parameters with the virtual commercial entity.

5. A method of claim 4 further comprising, linking at least one financial account to the virtual commercial entity.

6. A virtual commercial entity generation and management system including:
a user request device configured to communicate data representing at least a request for a virtual commercial entity with a data network;
a virtual commercial entity generation and management server having at least one processor and configured by code executing therein to:
receive data from the user request device over the data network,
extrapolate the data representing at least a request for a virtual commercial entity into a first array, wherein the extrapolated data represents one or more operational conditions of a virtual commercial entity and one or more variable data features corresponding to a third party vendor,
generate an electronic charter incorporating each element in the first array,
access a database of prior electronic charters,
select automatically the value for at least one variable value data feature based on a regression analysis of prior electronic charters, and
generate a virtual commercial entity associated with the electronic charter.

7. The system of claim 6, the processor further configured by code to:
receive user input relating to the performance level of at least one third party vendor,
update the database of electric charters to reflect the performance level of the at least one third party vendor.

8. The system of claim 6, wherein the virtual commercial entity generation and management server is a collection of distributed computing elements.

9. The system of claim 6, wherein the user request device is a mobile computing device equipped with a communications module for wirelessly transmitting data.

10. The system of claim 6 wherein the virtual commercial entity generation and management server is further configured to encrypt data prior to transmitting data between the virtual commercial entity generation and user request device.
